(19) United States
(12) Patent Application Publication
(10) Pub. No.: US 2024/0324522 A1
(43) Pub. Date: Oct. 3, 2024

(54) A MODULAR GREEN WALL ELEMENT WITH IMPROVED THERMAL INSULATION PROPERTIES

(71) Applicant: SIKA TECHNOLOGY AG, Baar (CH)

(72) Inventors: Wilfried CARL, Kreuzlingen (CH); Roy Z'ROTZ, Ebikon (CH); Aline ROTZETTER, Wettingen (CH); Herbert ACKERMANN, Tann (CH); Patricia HEIDTMAN, Kriens (CH)

(73) Assignee: SIKA TECHNOLOGY AG, Baar (CH)

(21) Appl. No.: 18/293,447

(22) PCT Filed: Aug. 22, 2022
(86) PCT No.: PCT/EP2022/073267

§ 371 Date: Jan. 30, 2024

(30) Foreign Application Priority Data
Aug. 24, 2021 (EP) 21192845.2

(51) Int. Cl. A01G 9/02

(52) U.S. Cl. CPC A01G 9/025

(57) ABSTRACT

A modular green wall element includes a casing having a first and a second compartment, wherein the first compartment is arranged to host a growing material for plants and wherein the second compartment is at least partially filled with a foamed material to provide the element with improved thermal insulation properties.

### TECHNICAL FIELD

The invention relates to the field of green wall elements. Particularly, the invention relates to modular prefabricated green wall elements having improved thermal insulation properties.

### BACKGROUND OF THE INVENTION

Exterior surfaces of buildings must be protected from environmental forces such as wind and rain. Buildings must also be thermally insulated to prevent unnecessary flow of heat energy from inside to outside of the building or vice versa. Furthermore, for ecological reasons, it is very desirable to cover building facades with green (vegetated) wall systems, which improves the urban microclimate, provides some thermal insulation, and enhances the aesthetics. Particularly, the green wall systems play an important role as an urban climate buffer, not only by sequestration of carbon dioxide, but also by reducing the heat island effect, improving general air quality, sound and heat insulation, as well as by saving energy- and water, improve urban biodiversity, and the wellbeing of the urban citizens. Consequently, modular green wall elements are gaining increasing importance.

Modular systems for providing green walls have been commercially available for quite some time. However, the currently available green wall modules are “add on” systems that are installed onto the exterior surface of the building envelope, which means that they must be adhered above the existing thermal insulation layer. To ensure sufficient adhesion strength, metallic fasteners penetrating the insulation layers are typically used for fastening the green wall elements to the building structure. This has a significant drawback of generating heat bridges connecting the underside of the insulation layer with the external side of the building.

It would thus be highly desirable to have a modular green wall element having an integrated thermal insulation which when installed essentially covers the whole facade area and avoids the formation of thermal bridges between the internal and external sides of the building envelope. The green wall element would preferably also be lightweight and have excellent fire resistance properties.

### SUMMARY OF THE INVENTION

The object of the present invention is to provide a modular green wall element having an integrated thermal insulation, which can be used for providing green walls covering the whole outer surface of a facade without the formation of thermal bridges between the inner and outer sides of the building envelope.

Another object of the present invention is to provide a modular green wall element that is lightweight and has excellent fire resistance properties.

The subject of the present invention is a modular green wall element as defined in claim 1.

It has been surprisingly found out that the objectives can be achieved with the features of claim 1.

One of the advantages of the present invention is that it enables covering entire façade surfaces with green wall elements without having a negative impact on the thermal insulation properties of the building envelope.

The core of the invention is a modular green wall element comprising a casing having at least two cavities (compartments), wherein the first cavity can be filled with a growing material for plants, such as soil, whereas the second cavity is at least partially filled with a foamed organic or inorganic material to improve the thermal insulation properties of the element.

Other subjects of the present invention are presented in other independent claims. Preferred aspects of the invention are presented in the dependent claims.

### BRIEF DESCRIPTION OF FIGURES

FIG. 1 shows a green wall element (1) comprising a casing (2) having first and second compartments (6, 6′), wherein the inner space of the second compartment (6′) is partially filled with a foamed material.

FIG. 2 shows a casing (2) of a green wall element comprising front and rear walls (3, 3′) connected by two longitudinal side walls (4, 4′), a bottom wall (7), and an intermediate wall (5) dividing the inner space formed between the front, rear, and longitudinal side walls (3, 3′, 4, 4′) into first and second compartments (6, 6′).

FIG. 3 shows a casing (2) of a green wall element comprising front and rear walls (3, 3′) connected by two longitudinal side walls (4, 4′), a bottom wall (7), and an intermediate wall (5) dividing the inner space formed between the front, rear, and longitudinal side walls (3, 3′, 4, 4′) into first and second compartments (6, 6′) and a further intermediate wall (5′) dividing the inner space of the first compartment (6) into first and second sub-compartments (6a, 6b).

FIG. 4 shows a green wall comprising a substrate (8) and a plurality of modular green wall elements attached to a surface of the substrate (8) such that each element (1) is connected to the surface of the substrate (8) via an outer surface of its rear wall (3′). Adjacent elements are attached to each other via outer surfaces of their opposing longitudinal side walls (4, 4′).

### DETAILED DESCRIPTION OF THE INVENTION

The subject of the present invention is a modular green wall element (1) comprising a casing (2) having a first and a second compartment (6, 6′), wherein the first compartment (6) is arranged to host a growing material for plants, such as soil, and wherein the second compartment (6′) is at least partially filled with a foamed material.

Substance names beginning with “poly” designate substances which formally contain, per molecule, two or more of the functional groups occurring in their names. For instance, a polyol refers to a compound having at least two hydroxyl groups. A polyether refers to a compound having at least two ether groups.

The term “polymer” designates a collective of chemically uniform macromolecules produced by a polyreaction (polymerization, polyaddition, polycondensation) where the macromolecules differ with respect to their degree of polymerization, molecular weight and chain length. The term also comprises derivatives of said collective of macromolecules resulting from polyreactions, that is, compounds which are obtained by reactions such as, for example, additions or substitutions, of functional groups in predetermined macromolecules and which may be chemically uniform or chemically non-uniform.

The term “copolymer” refers in the present disclosure to a polymer derived from more than one species of monomer (“structural unit”). The polymerization of monomers into copolymers is called copolymerization. Copolymers obtained by copolymerization of two monomer species are known as bipolymers and those obtained from three and four monomers species are called terpolymers and quaterpolymers, respectively.

The term “rubber” designates a polymer or a polymer blend, which is capable of recovering from large deformations, and which can be, or already is, modified to a state in which it is essentially insoluble (but can swell) in a boiling solvent, in particular xylene. Typical rubbers are capable of being elongated or deformed to at least 200% of their original dimension under an externally applied force, and will substantially resume the original dimensions, sustaining only small permanent set (typically no more than about 20%), after the external force is released. The term “rubber” may be used interchangeably with the term “elastomer”.

The term “melting temperature (Tm)” refers to a melting point determined as a maximum of the curve determined by means of differential scanning calorimetry (DSC) using the measurement method as defined in ISO 11357-3:2018 standard using a heating rate of 2° C./min. The measurements can be performed with a Mettler Toledo DSC 3+ device and the Tm values can be determined from the measured DSC-curve with the help of the DSC-software. In case the measured DSC-curve shows several peak temperatures, the first peak temperature coming from the lower temperature side in the thermogram is taken as the melting temperature (Tm).

The “amount or content of at least one component X” in a composition, for example “the amount of the at least one synthetic polymer” refers to the sum of the individual amounts of all synthetic polymers contained in the composition. For example, in case the composition comprises 20 wt.-% of at least one synthetic polymer, the sum of the amounts of all synthetic polymers contained in the composition equals 20 wt.-%.

The term “normal room temperature” designates a temperature of 23° C.

The green wall element is preferably a preformed article. The term “preformed” or “prefabricated” is understood to mean that the element has been formed before being applied on a surface to be covered with the element. Particularly, the term “preformed” refers to elements, which have not been formed in situ, i.e. not been formed on the surface of the substrate to be covered with the element. Preformed green wall elements are typically, although not necessarily, fabricated at a location that is remote from the construction site, brought to the site, and laid on a surface of a substrate to be covered with the element.

The term “foamed material” refers to a material having a plurality of distinct void spaces formed therein. Suitable foamed materials for use in the green wall element of the present invention include closed cell, semi-closed (semi-open) cell, and open cell synthetic organic and inorganic foams. Closed and semi-closed cell foams may be preferred to minimize the ability of the foamed material to absorb liquids, particularly water.

Preferably, the foamed material has a density of not more than 500 kg/m³ (g/i), more preferably not more than 300 kg/m³ (g/l), even more preferably not more than 250 kg/m³ (g/l), still more preferably not more than 200 kg/m³ (g/l), such as 15-250 kg/m³ (g/l), preferably 25-150 kg/m³ (g/l).

The density of the foamed material is preferably measured gravimetrically, for example by using the following procedure. A sample cube having dimensions of 10×10×10 cm is first cut from the foamed material and dried in an oven at a temperature of 70° C. until the weight of the material remains constant. The weight of the sample cube is then measured, and the density of the material is obtained based on the measured weight and volume of the cube.

According to one or more embodiments, the foamed material is a synthetic organic foamed material, preferably selected from the group consisting of polystyrene, polyurethane, polyisocyanurate, and polyolefin foam, and expanded rubber.

Polyolefin foams and expanded rubbers are typically produced by adding a chemical blowing agent into a polyolefin melt or a curable rubber composition. Polystyrene-based foams, such as expanded polystyrene (EPS) and expanded extruded polystyrene (XPS) are obtained by expanding a starting composition with an expansion agent, such as pentane, or by extruding a melted composition through an extruder nozzle, wherein the reduction in pressure causes the liquid material to expand.

Polyurethane (PUR) and polyisocyanurate (PIR) foams are formed by reacting isocyanates with polyols. During the expansion process, the closed pores are filled with an expansion gas, such as carbon dioxide or hexane.

According to one or more embodiments, the synthetic organic foamed material is selected from the group consisting of polystyrene, polyurethane, polyisocyanurate, and polyolefin foam.

According to one or more preferred embodiments, the foamed material is a foamed inorganic material comprising:
a) At least one mineral binder B and
b) Optionally at least one synthetic organic polymer SP.

Compared to the foamed organic materials, the foamed inorganic materials have the significant advantage of providing an excellent fire resistance properties.

Suitable mineral binders include hydraulic binders, such as cement and hydraulic lime, calcium sulfates, and air-hardening binders, such as non-hydrated lime, and latent hydraulic and pozzolanic binder materials.

Hydraulic binders are inorganic materials or blends, which form a paste when mixed with water, and which set and harden by a series of hydration reactions resulting in formation of solid mineral hydrates or hydrate phases, which are not soluble in water or have a very low water-solubility. Hydraulic binders, such as Portland cement, can harden and retain their strength even when exposed to water, for example underwater or under high humidity conditions. The term “non-hydraulic binder” refers to substances, which harden by reaction with carbon dioxide and which, therefore, do not harden in wet conditions or under water.

Examples of suitable non-hydraulic binders include air-slaked lime (non-hydraulic lime) and calcium sulfate. The term “calcium sulfate” is understood to include calcium sulfate anhydride (CaSO₄), calcium sulfate hemihydrate (CaSO₄·½H₂O), and calcium sulfate dihydrate (CaSO₄·2 H₂O).

Furthermore, the term “calcium sulfate hemihydrate” is understood to include both alpha and beta calcium sulfate hemihydrates. Preferred calcium sulfates include the ones derived from REA gypsum, phosphor gypsum, and nature gypsum. The term “REA gypsum” refers here to a gypsum obtained in so-called flue gas desulphurization plants.

The term “latent hydraulic binder material” refers to type II concrete additives with a “latent hydraulic character” as defined in DIN EN 206-1:2000 standard. These types of mineral binders are calcium aluminosilicates that are not able to harden directly or harden too slowly when mixed with water. The hardening process is accelerated in the presence of alkaline activators, which break the chemical bonds in the binder's amorphous (or glassy) phase and promote the dissolution of ionic species and the formation of calcium aluminosilicate hydrate phases. Examples of latent hydraulic binders include ground granulated blast furnace slag. Ground granulated blast furnace slag is typically obtained from quenching of molten iron slag from a blast furnace in water or steam to form a glassy granular product and followed by drying and grinding the glassy into a fine powder.

Term “pozzolanic binder material” refers to type II concrete additives with a “pozzolanic character” as defined in DIN EN 206-1:2000 standard. These types of mineral binders are siliceous or aluminosilicate compounds that react with water and calcium hydroxide to form calcium silicate hydrate or calcium aluminosilicate hydrate phases. Examples of pozzolanic binders include natural pozzolans, such as trass, and artificial pozzolans, such as fly ash and silica fume. The term “fly ash” refers to the finely divided ash residue produced by the combustion of pulverized coal, which is carried off with the gasses exhausted from the furnace in which the coal is burned. The term “silica fume” refers to fine particulate silicon in an amorphous form. Silica fume is typically obtained as a by-product of the processing of silica ores such as the smelting of quartz in a silica smelter which results in the formation of silicon monoxide gas and which on exposure to air oxidizes further to produce small particles of amorphous silica.

Preferably, the at least one mineral binder B makes up at least 35 wt.-%, preferably at least 50 wt.-%, more preferably at least 65 wt.-%, even more preferably at least 75 wt.-%, of the total weight of the foamed inorganic material.

Preferably, the at least one mineral binder B is selected from the group consisting of Portland cement, calcium aluminate cement, calcium sulfoaluminate cement, latent hydraulic binder materials, pozzolanic binder materials, calcium sulfate, and hydrated lime.

According to one or more preferred embodiments, the at least one mineral binder B comprises at least one hydraulic binder B1, preferably selected from the group consisting of Portland cement, calcium aluminate cement, and calcium sulfoaluminate cement.

Generally, the expression “the at least one component X comprises at least one component XN”, such as “the at least one mineral binder B comprises at least one hydraulic binder B1” is understood to mean in the context of the present disclosure that a composition comprises one or more hydraulic binders B1 as representatives of the at least one mineral binder B.

The term “Portland cement” as used herein is intended to include those cements normally understood to be “Portland cements”, particularly those described in European Standard EN-197. Portland cement consists mainly of tri-calcium silicate (alite) (C₃S) and dicalcium silicate (belite) (C₂S). Preferred Portland cements include the types CEM I, CEM II, CEM III, CEM IV, and CEM V compositions of the European standard EN 197-1:2018-11. However, all other Portland cements that are produced according to another standard, for example, according to ASTM standard, British (BSI) standard, Indian standard, or Chinese standard are also suitable.

The term “aluminate cement” as used herein is intended to include those cementitious materials that contain as the main constituent (phase) hydraulic calcium aluminates, preferably mono calcium aluminate CA (CaO·Al₂O₃). Depending on the type of the aluminate cement, other calcium aluminates, such as CA₂, C₃A, and C₁₂A₇, may also be present. Preferred aluminate cements include also other constituents, such as belite (C₂S), alite (C₃S), ferrites (C₂F, C₂AF, C₄AF), and ternesite (C₅S₂\check{\dot{S}}). Some aluminate cements also contain calcium carbonate.

Most preferred aluminate cements for use as the at least one hydraulic binder B1 include calcium aluminate cements (CAC), which fulfill the requirements of the norm EN 4647 (“Calcium Aluminate Cement”). Suitable calcium aluminate cements are commercially available, for example, from Imerys Aluminates and Royal White Cement.

The term “calcium sulfoaluminate cement (CSA)” is intended to include those cementitious materials that contain as the main constituent (phase) C₄(A₃-xFx)3\check{\dot{S}}(4CaO·3-x Al₂O₃·x Fe2O3·CaSO₄), wherein x has a value of 0,1, 2, or 3. Typically, calcium sulfoaluminate cements also include other constituents, such as aluminates (CA, C₃A, C₁₂A₇), belite (C₂S), ferrites (C₂F, C₂AF, C₄AF), ternesite (C₅S₂\check{\dot{S}}), and calcium sulfate. Preferred calcium sulfoaluminate cements for use as the at least one hydraulic binder B1 contain 20-80 wt.-% of ye'elimite (C₄A₃\check{\dot{S}}), 0-10 wt.-% of calcium aluminate (CA), 0-70 wt.-% of belite (C₂S), 0-35 wt.-% of ferrite, preferably tetracalcium aluminoferrite (C₄AF), and 0-20 wt.-% of ternesite (C5S2\check{\dot{S}}), based on the total weight of the calcium sulfoaluminate cement. Suitable calcium aluminate cements (CAS) are commercially available, for example, from Heidelberg Cement A G, Vicat S A, and Caltra B. V.

Preferably, the at least one hydraulic binder B1 comprises at least 50 wt.-%, more preferably at least 65 wt.-%, even more preferably at least 75 wt.-%, of the total weight of the at least one mineral binder B. According to one or more embodiments, the at least one mineral binder B is a hydraulic binder, preferably selected from the group consisting of Portland cement, calcium aluminate cement, and calcium sulfoaluminate cement, preferably Portland cement.

According to one or more embodiments, the weight ratio of the amount of the at least one mineral binder B to the amount of the at least one synthetic polymer SP in the foamed inorganic material is from 100:0 to 70:30, preferably from 100:0 to 80:20.

According to one or more embodiments, the proportion of the at least one synthetic polymer SP is 1-25 wt.-%, preferably 5-15 wt.-%, more preferably 8-12 wt.-%, with respect to the weight of the at least one mineral binder B in the foamed inorganic material.

The at least one synthetic organic polymer SP may be used to improve mechanical properties, particularly the compressive strength and/or bending strength, of the foamed inorganic material.

The type of the synthetic polymer SP is not particularly restricted. Suitable synthetic organic polymers include, for example, polyurethane polymers and homopolymers and copolymers obtained from free radical polymerization of one or more monomers selected from the group consisting of ethylene, propylene butylene, isoprene, butadiene, styrene, acrylonitrile, (meth)acrylic acid, (meth)acrylate, vinyl ester, vinyl neodecanoate, vinyl alcohol, and vinyl chloride. The term “(meth)acrylate” refers to acrylate and methacrylate and term “(meth)acrylic” refers to acrylic and methacrylic.

The term “polyurethane polymer” refers polymers prepared by so called diisocyanate polyaddition process, including those polymers which are almost or completely free of urethane groups. Examples of suitable polyurethane polymers include polyether polyurethanes, polyester polyurethanes, polyether polyureas, polyureas, polyester polyureas, polyisocyanurates, and polycarbodiimides.

According to one or more embodiments, the at least one synthetic organic polymer SP is a polyurethane polymer, preferably based on at least one polyisocyanate and at least one polyol and/or polyamine monomer.

Suitable polyisocyanates include monomeric polyisocyanates, as well as oligomers, polymers, and derivatives of monomeric polyisocyanates, and mixtures thereof.

Suitable monomeric polyisocyanates for polyurethane polymers include at least aromatic di- and tri-functional isocyanates, such as 2,4- and 2,6-toluylendiisocyanate and mixtures of its isomers (TDI), 4,4′-, 2,4′- and 2,2′-diphenylmethandiisocyanate and mixture of its isomers (MDI), 1,3- and 1,4-phenylendiisocyanate, 2,3,5,6-tetramethyle-1,4-diisocyanatobenzol, naphthaline-1,5-diisocyanate (NDI), 3,3′-dimethyl-4,4′-diisocyanato diphenyl (TODI), dianisidindiisocyanate (DADI), 1,3,5-tris-(isocyanatomethyl)benzene, tris-(4-isocyanatophenyl)methane and tris-(4-isocyanatophenyl) thiophosphate.

Further suitable monomeric polyisocyanates for polyurethane polymers include aliphatic di- and tri-functional isocyanates, such as 1,4-tetramethylendiisocyanat, 2-methylpentamethylene-1,5-diisocyanate, 1,6-hexamethylendiisocyanate (HDI), 2,2,4- and 2,4,4-trimethyl-1,6-hexa-methylendiisocyanate (TMDI), 1,10-decamethylendiisocyanate, 1,12-dodecame-thylendiisocyanat, lysin- and Iysinesterdiisocyanate, cyclohexane-1,3- and -1,4-diisocyanate, 1-methyl-2,4- and -2,6-diisocyanatocyclohexane and mixtures of its isomers (HTDI or H6TDI), 1-isocyanato-3,3,5-trimethyl-5-iso-cyanatomethyl-cyclohexane (=isophorondiisocyanate or IPDI), perhydro-2,4′- and -4,4′-diphenylmethandiisocyanate (HMDI or H12MDI), 1,4-diisocyanato-2,2,6-trimethylcyclohexane (TMCDI), 1,3- and 1,4-Bis-(isocyanatomethyl)cyclo-hexane, m- and p-xylylendiisocyanate (m- and p-XDI), m- and p-tetramethyle-1,3- and -1,4-xylylendiisocyanate (m- and p-TMXDI), bis-(1-isocyanato-1-methyl-ethyl)naphthaline, dimer- and trimer fatty acid isocyanate such as 3,6-bis-(9-isocya-natononyl)-4,5-di-(1-heptenyl)cyclohexen (dimeryldiisocyanat) and α, α, α′, α′, α″, α″-hexamethyl-1,3,5-mesitylentriisocyanate.

Particularly suitable polyols for polyurethane polymers include polyether polyols, polyester polyols, polycarbonate polyols, poly(meth)acrylate polyols, and hydrocarbon polyols, such as polybutadiene polyols, polyhydroxy functional fats and oils, and polyhydroxy functional acrylonitrile-butadiene copolymers.

Particularly suitable polyether polyols include polyoxyalkylene diols and/or polyoxyalkylene triols, especially the polymerization products of ethylene oxide or 1,2-propylene oxide or 1,2- or 2,3-butylene oxide or oxetane or tetrahydrofuran or mixtures thereof, which can be polymerized with using a starter molecule having two or three active hydrogen, in particular one, such as water, ammonia or a compound with several OH or NH groups, such as 1,2-ethanediol, 1,2- or 1,3-propanediol, neopentyl glycol, diethylene glycol, triethylene glycol, the isomeric dipropylene glycols or tripropylene glycols, the isomeric butanediols, pentanediols, hexanediols, heptanediols, octanediols, nonanediols, decanediols, undecanediols, 1,3- or 1,4-cyclohexanedimethanol, bisphenol A, hydrogenated bisphenol A, 1,1,1-trimethylolethane, 1,1,1-trimethylolpropane, glycerol or aniline, or mixtures of the aforementioned compounds.

Suitable polyester polyols include liquid polyester polyols as well as amorphous, partially crystalline, and crystalline polyester polyols, which are solid at a temperature of 25° C. These can be obtained from by reacting dihydric and trihydric, preferably dihydric, alcohols, for example, 1,2-ethanediol, diethylene glycol, triethylene glycol, 1,2-propanediol, 1,3-propanediol, dipropylene glycol, 1,4-butanediol, 1,5-pentanediol, 1,6-hexanediol, 1,8-octanediol, 1,10-decanediol, 1,12-dodecanediol, dimer fatty alcohol, neopentyl glycol, glycerol, 1,1,1-trimethylolpropane or mixtures of the aforesaid alcohols, with organic dicarboxylic acids or tricarboxylic acids, preferably dicarboxylic acids, or their anhydrides or esters, such as succinic acid, glutaric acid, 3,3-dimethylglutaric acid, adipic acid, suberic acid, sebacic acid, undecanedioic acid, dodecanedicarboxylic acid, azelaic acid, maleic acid, fumaric acid, phthalic acid, dimer fatty acid, isophthalic acid, terephthalic acid, and hexahydrophthalic acid, or mixtures of the aforesaid acids, and also polyester polyols made from lactones such as from s-caprolactone, for example, also known as polycaprolactones.

Suitable polyamine monomers are compounds having two or more isocyanate reactive amine groups. Examples of employable polyamine monomers include diethyltolylenediamine, methylbis(methylthio)phenylenediamine, adipic dihydrazide, ethylenediamine, diethylenetriamine, triethylenetetramine, tetraethylenepentamine, pentaethylenehexamine, dipropylenetriamine, hexamethylenediamine, hydrazine, isophoronediamine, N-(2-aminoethyl)-2-aminoethanol, polyoxyalkyleneamine, adducts of salts of 2-acrylamido2-methylpropane-1-sulfonic acid (AMPS) and ethylenediamine, adducts of salts of (meth)acrylic acid and ethylendiamine, adducts of 1,3-propanesulfone and ethylenediamine or any desired combination of these polyamines.

According to one or more preferred embodiments, the at least one synthetic organic polymer SP is selected from the group consisting of polyacrylates, styrene-acrylate copolymers, polyvinyl esters, ethylene-vinyl acetate copolymers, ethylene-vinyl alcohol copolymers, styrene-butadiene copolymers, vinyl acetate-vinyl neodecanoate (VeoVa) copolymers, and polyurethane polymers.

According to one or more preferred embodiments, the at least one synthetic organic polymer SP comprises at least one ethylene-vinyl acetate copolymer and/or at least one terpolymer of ethylene, vinyl acetate, and vinyl ester monomers.

Especially suitable ethylene-vinyl acetate copolymers for use as the at least one synthetic organic polymer SP have a content of a structural unit derived from vinyl acetate of not more than 40 wt.-%, preferably not more than 30 wt.-%, more preferably not more than 20 wt.-%, still more preferably not more than 15 wt.-%, based on the weight of the copolymer.

According to one or more embodiments, the foamed inorganic material further comprises at least one surfactant S. The term “surfactant” refers here to surface tension lowering substances, which are usually organic compounds containing both hydrophobic and hydrophilic groups.

Surfactants may be used to stabilize the foam structure during preparation of the foamed inorganic material.

Surfactants are well known to the specialist and are summarized, for example, in “Surfactants and Polymers in aqueous solutions” (Wiley-VCH, K. Holmberg et al, 2^{nd} Edition, 2007). Suitable surfactants include at least non-ionic surfactants, cationic surfactants, anionic surfactants, and amphoteric surfactants. Amphoteric (zwitterionic) surfactants have both cationic and anionic centers attached to the same molecule.

It may be particularly advantageous to use non-ionic surfactants, since they have a low tendency to be absorbed by cement phases. However, it is also possible to use cationic, anionic or amphoteric (zwitterionic) surfactants.

Suitable surfactants in the context of the present invention include lipids such as cholates, glycocholates, fatty acid salts, glycerides, glycolipids and phospholipids. These may be derived from natural sources or may be synthetically produced. Non-ionic lipids are preferred in certain embodiments.

Suitable anionic surfactants include compounds containing carboxylate, sulfate, phosphate or sulfonate groups, such as organosulfates, alkyl ether carboxylates, alkyl sulfates, alkyl ether sulfates, fatty alcohol sulfates, alkyl sulfosuccinates, alkylphenol ethoxylates, olefinsulfonates, alkyl phosphates, alkyl ether phosphonates, and alkyl benzene sulfonates.

Suitable non-ionic surfactants include, particularly, fatty acid alkoxylates, alkoxylated alcohols, especially fatty acid alcohol alkoxylates and alkoxylates of glycerol and pentaerythritol, alkylphenol alkoxylates, alkoxylated polysaccharides, alkoxylated polycondensates, fatty acid amide alkoxylates, ethanolamides, esters of fatty acids, especially fatty acid esters of methanol, sorbitan, glycerol or pentaerythritol, alkoxylated alkylamines with an alkyl radical consisting of 6-20 carbon atoms, alkyl glycosides, alkyl glucamides, esters of fatty acids and sugars, polysiloxanes, as well as alkoxylated sorbitans, copolymers of ethylene oxide and propylene oxide, lauryl ether sulphonates, naphthalene sulphonates, hydrophobized starch, hydrophobized cellulose or siloxane-based surfactants. Preferred alkoxylates in this context are particularly ethoxylates.

Suitable cationic surfactants contain particularly ammonium groups or quaternary nitrogen atoms and have at least one long-chain alkyl radical. Examples of suitable cationic surfactants are quaternary ammonium compounds with at least one alkyl group, phosphonium compounds, such as tetraalkylammonium salts, imidazolines, such as N,N-dialkylimidazoline compounds, dimethyldistearylammonium compounds, N-alkylpyridine compounds, ammonium chlorides, and amine N-oxides. For example, a cationic surfactant can be chosen from tetradecyltrimethylammonium bromide (TTAB), Cetyltrimethylammonium bromide (CTAB), and Dodecyltrimethylammonium bromide (DTAB).

According to one or more embodiments, the at least one surfactant S comprises or consist of at least one Gemini surfactant.

Gemini surfactants contain two hydrophilic head groups and two hydrophobic tails separated by a spacer at or near the head groups. When both hydrophobic tails are the same and the hydrophilic groups are identical, Gemini surfactants are said to have a symmetrical structure. The substituents in Gemini surfactants are largely responsible for the behavior of these compounds in solution and their potential applications. Particularly, Gemini surfactants may contain quaternary nitrogen atoms, which are usually present in acyclic forms. However, there are also Gemini surfactants that contain nitrogen in saturated and unsaturated rings. The spacer can be either rigid or flexible, tending to be hydrophobic or hydrophilic. The special properties of Gemini surfactants can be influenced by optimizing the hydrophilic-lipophilic balance (HLB value). This can be done, for example, by introducing balanced polar or hydrophobic groups in both head groups, tails or spacers. Examples of preferred Gemini surfactants are particularly alkoxylated acetyldiols or Gemini surfactants as described in EP 0 884 298.

According to one or more further embodiments, the at least one surfactant S comprises an anionic surfactant and/or a non-ionic surfactant, preferably a mixture of an anionic surfactant and/or a non-ionic surfactant.

According to one or more further embodiments, the at least one surfactant S is an amphoteric surfactant, preferably selected from aminocarboxylic acids and betaines, especially fatty acid amido alkyl betaines, particularly cocamidopropyl betaine. Betaines are neutral chemical compound with a positively charged cationic functional group, such as quaternary ammonium or phosphonium cation, that bears no hydrogen atom, and with a negatively charged functional group such as a carboxylate group that may not be adjacent to the cationic site. A betaine is thus a specific type of a zwitterion. These kinds of surfactants turned out to be highly beneficial in the context of the present invention since they are highly compatible with the further constituents that are typically present in the foamed inorganic material.

According to one or more embodiments, the casing (2) has:
front and rear walls (3, 3′) connected by two longitudinal side walls (4, 4′),
an intermediate wall (5) dividing the inner space formed between the front, rear, and longitudinal side walls (3, 3′, 4, 4′) into the first and second compartments (6, 6′), and
a bottom wall (7).

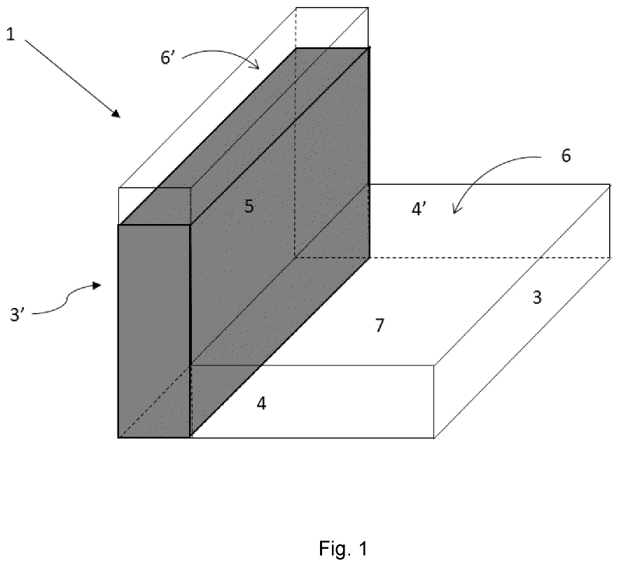

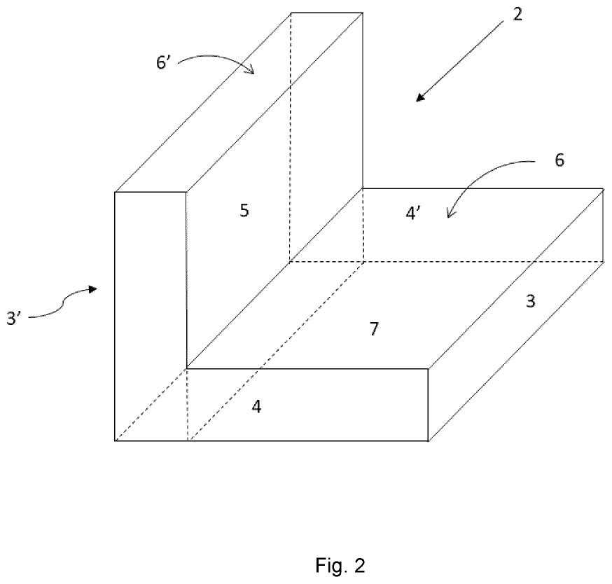

Preferably, the intermediate wall (5) extends transversely to the direction of the longitudinal side walls (4, 4′). In this case the first compartment (6) is limited by the front, intermediate, and longitudinal side walls (3, 5, 4, 4′) and the second compartment (6′) is limited by the rear, intermediate, and longitudinal side walls (3′, 5, 4, 4′), as shown in FIGS. 1 and 2.

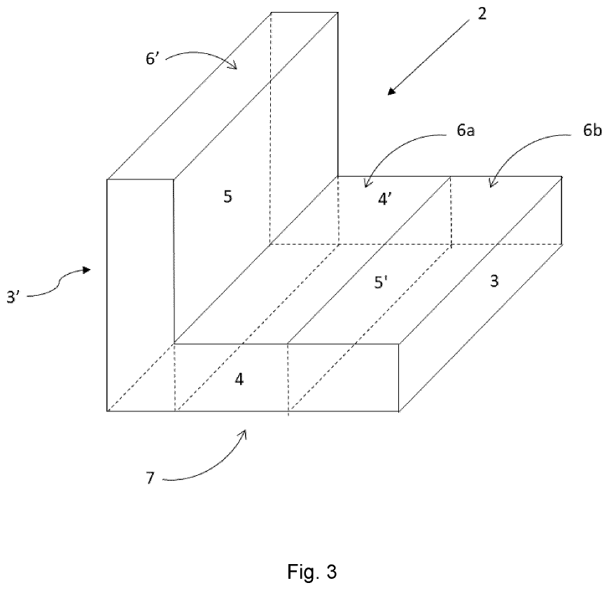

It is also possible, but not necessarily preferred, that the casing (2) comprises further intermediate walls, which divide the inner space of first and/or second compartment (6, 6′) into further sub-compartments. According to one or more embodiments, the casing (2) comprises a further intermediate wall (5′) dividing the inner space of the first compartment (6) into first and second sub-compartments (6a, 6b), as shown in FIG. 3.

According to one or more embodiments, the rear wall (3′) and the intermediate wall (5) have substantially same height and/or wherein the height of the front wall (3) is at least 10%, preferably at least 25%, more preferably at least 35%, smaller than the height of the rear wall (3′). The expression “substantially same height” is understood to mean that difference between the heights of the rear and intermediate walls (3′, 5) is negligible, such as less than 1.5%, preferably less than 1%, more preferably less than 0.5%, of the sum of the heights of the rear and intermediate walls (3′, 5).

According to one or more embodiments, the depth of the second compartment (6′) measured in direction of the longitudinal side walls (4, 4′) is at least 10%, preferably at least 25%, more preferably at least 35%, smaller than the depth of the first compartment (6) measured in direction of the longitudinal side walls (4, 4′).

Preferably, the green wall element is arranged to be attached to a surface of substrate, particularly a building element, such as a wall or façade of a building, via an outer surface of the rear wall (3′) facing away from the intermediate wall (5).

Once attached to a substrate, the outer surface of the rear wall (3′) and the surface of the substrate can be indirectly or directly connected to each other. The expression “directly connected” is understood to mean in the context of the present invention that no further layer or substance is present between the layers and that the opposing surfaces of the layers are directly bonded to each other or adhere to each other. At the transition area between the two layers, the materials of the layers can also be present mixed with each other. The opposing surfaces can be indirectly connected to each other via a connecting layer, such as a layer of an adhesive.

The angle formed between the plane of the rear wall (3′) and the plane of the bottom wall (7) and/or between the plane of the intermediate wall (5) the plane of the bottom wall (7) and/or between the plane of the front wall (3) and the plane of the bottom wall (7) and/or between the planes of the longitudinal side walls (4, 4′) and the plane of the bottom wall (7) is preferably in the range of 85-95° C., more preferably 87.5-92.5° C., even more preferably 88.5-91.5° C.

It is also preferred that the front, rear, intermediate, and the longitudinal side walls (3, 3′, 5, 4, 4′) extend substantially vertically when the element has been attached to a vertical surface of a substrate, such as a wall or façade of building via the rear wall (3′) of the casing (2).

Furthermore, the bottom wall (7) preferably extends substantially horizontally when the element has been attached to a vertical surface of a substrate, such as a wall or façade or a building via the rear wall (3′) of the casing (2).

The thickness of the walls of the casing (2) may be constant or non-constant over the length and/or width of the respective wall. According to one or more embodiments, the thickness of the front, rear, longitudinal side, intermediate, and bottom wall (3, 3′, 4, 4′, 5, 7) is substantially constant over the length and/or width of the respective wall.

Preferably, the thickness of the walls (3, 3′, 4, 4′, 5, 7) is not more than 25 mm, more preferably not more than 15 mm, even more preferably not more than 10 mm. According to one or more embodiments, the walls (3, 3′, 4, 4′, 5, 7) of the casing (2) have a thickness of 0.1-5 mm, preferably 0.25-3.5 mm, more preferably 0.35-2.5 mm. Casings having a thickness of the walls falling within the above cited ranges can be easily produced by using conventional processing techniques for thermoplastic materials, such as extrusion, injection molding, and additive manufacturing techniques.

The preferred dimensions of the green wall element depend on application requirements. It may be preferred that the element has a width and/or length in the range of 15-300 cm, more preferably 25-250 cm, even more preferably 35-200 cm.

The casing of the green wall element is preferably composed of a polymeric material. As used herein, the term “polymeric” refers to a material having one or more polymers as main constituents.

Suitable polymers for use in the casing of the green wall element include, for example, polyvinylchloride, polyolefins, halogenated polyolefins, ethylene ketone esters, thermoplastic polyesters, polyamides, and acrylonitrile butadiene styrene, and rubbers.

Suitable polyolefins include ethylene-based polyolefins, for example, polyethylenes, and ethylene copolymers, such as copolymers of ethylene and one or more α-olefins, copolymers of ethylene and vinyl acetate, and copolymers of ethylene and acrylic esters. Further suitable polyolefins include propylene-based polyolefins, for example polypropylenes and propylene copolymers, such as copolymers propylene and one or more α-olefins. Suitable thermoplastic polyesters include, for example, polyethylene terephthalate and polybutylene terephthalate.

Suitable rubbers include butyl rubber, halogenated butyl rubber, ethylene-propylene diene monomer rubber, natural rubber, chloroprene rubber, synthetic 1,4-cis-polyisoprene, polybutadiene, ethylene-propylene rubber, styrene-butadiene copolymer, isoprene-butadiene copolymer, styrene-isoprene-butadiene rubber, methyl methacrylate-butadiene copolymer, methyl methacrylate-isoprene copolymer, acrylonitrile-isoprene copolymer, and acrylonitrile-butadiene copolymer.

According to one or more embodiment, the polymeric material of the casing comprises at least one polymer P selected from the group consisting of polyvinylchloride, polyethylene, ethylene α-olefin copolymers, ethylene acrylic ester copolymers, ethylene vinyl acetate copolymers, polypropylene, and propylene α-olefin copolymers.

Suitable polyethylenes for use as the at least one polymer P include, for example, very-low-density polyethylene, low-density polyethylene, linear low-density polyethylene, medium-density polyethylene, high-density polyethylene, and ultra-high-molecular-weight polyethylene, particularly low-density polyethylene, linear low-density polyethylene, medium-density polyethylene, high-density polyethylene.

Suitable ethylene α-olefin copolymers include random and block copolymers of ethylene and one or more C₃-C₂₀ α-olefin monomers, particularly one or more of propylene, 1-butene, 1-pentene, 1-hexene, 1-heptene, 1-octene, 1-decene, 1-dodecene, and 1-hexadodecene, preferably comprising at least 60 wt.-%, more preferably at least 65 wt.-% of ethylene-derived units, based on the weight of the copolymer.

Suitable ethylene random copolymers include, for example, ethylene-based plastomers, which are commercially available, for example, under the trade name of Affinity®, such as Affinity® EG 8100G, Affinity® EG 8200G, Affinity® SL 8110G, Affinity® KC 8852G, Affinity® VP 8770G, and Affinity® PF 1140G (all from Dow Chemical Company); under the trade name of Exact®, such as Exact® 3024, Exact® 3027, Exact® 3128, Exact® 3131, Exact® 4049, Exact®4053, Exact® 5371, and Exact® 8203 (all from Exxon Mobil); and under the trade name of Queo® (from Borealis AG) as well as ethylene-based polyolefin elastomers (POE), which are commercially available, for example, under the trade name of Engage®, such as Engage® 7256, Engage® 7467, Engage®7447, Engage® 8003, Engage® 8100, Engage® 8480, Engage® 8540, Engage® 8440, Engage® 8450, Engage® 8452, Engage® 8200, and Engage® 8414 (all from Dow Chemical Company).

Suitable ethylene-α-olefin block copolymers include ethylene-based olefin block copolymers (OBC), which are commercially available, for example, under the trade name of Infuse®, such as Infuse® 9100, Infuse® 9107, Infuse®9500, Infuse® 9507, and Infuse® 9530 (all from Dow Chemical Company).

Suitable copolymers of ethylene and vinyl acetate for use as the at least one polymer P include those having a content of a structural unit derived from vinyl acetate in the range of 4-95 wt.-%, preferably 6-90 wt.-%, more preferably 8-90 wt.-%, based on the weight of the copolymer. Suitable ethylene-vinyl acetate bipolymers and terpolymers, such as ethylene vinyl acetate carbon monoxide terpolymers, are commercially available, for example, under the trade name of Escorene® (from Exxon Mobil), under the trade name of Primeva® (from Repsol Quimica S.A.), under the trade name of Evatane® (from Arkema Functional Polyolefins), under the trade name of Greenflex® (from Eni versalis S.p.A.), and under the trade name of Levapren® (from Arlanxeo GmbH), and under the trade name of Elvaloy® (from Dupont).

Suitable polypropylenes for use as the at least one polymer P include, for example, isotactic polypropylene (iPP), syndiotactic polypropylene (sPP), and homopolymer polypropylene (hPP).

Suitable propylene copolymers include propylene-ethylene random and block copolymers and random and block copolymers of propylene and one or more C₄-C₂₀ α-olefin monomers, in particular one or more of 1-butene, 1-pentene, 1-hexene, 1-heptene, 1-octene, 1-decene, 1-dodecene, and 1-hexadodecene, preferably comprising at least 60 wt.-%, more preferably at least 65 wt.-% of propylene-derived units, based on the weight of the copolymer.

Suitable propylene random and block copolymers are commercially available, for example, under the trade names of Intune®, and Versify (from Dow Chemical Company) and under the trade name of Vistamaxx® (from Exxon Mobil).

Further suitable propylene copolymers for use as the at least one polymer P include heterophasic propylene copolymers. These are heterophasic polymer systems comprising a high crystallinity base polyolefin and a low-crystallinity or amorphous polyolefin modifier. The heterophasic phase morphology consists of a matrix phase composed primarily of the base polyolefin and a dispersed phase composed primarily of the polyolefin modifier. Suitable commercially available heterophasic propylene copolymers include reactor blends of the base polyolefin and the polyolefin modifier, also known as “in-situ TPOs” or “reactor TPOs or “impact copolymers (ICP)”, which are typically produced in a sequential polymerization process, wherein the components of the matrix phase are produced in a first reactor and transferred to a second reactor, where the components of the dispersed phase are produced and incorporated as domains in the matrix phase. Heterophasic propylene copolymers comprising polypropylene homopolymer as the base polymer are often referred to as “heterophasic propylene copolymers (HECO)” whereas heterophasic propylene copolymers comprising polypropylene random copolymer as the base polymer are often referred to as “heterophasic propylene random copolymers (RAHECO)”. The term “heterophasic propylene copolymer” encompasses in the present disclosure both the HECO and RAHECO types of the heterophasic propylene copolymers.

Depending on the amount of the polyolefin modifier, the commercially available heterophasic propylene copolymers are typically characterized as “impact copolymers” (ICP) or as “reactor-TPOs” or as “soft-TPOs”. The main difference between these types of heterophasic propylene copolymers is that the amount of the polyolefin modifier is typically lower in ICPs than in reactor-TPOs and soft-TPOs, such as not more than 40 wt.-%, particularly not more than 35 wt.-%. Consequently, typical ICPs tend to have a lower xylene cold soluble (XCS) content determined according to ISO 16152 2005 standard as well as higher flexural modulus determined according to ISO 178:2010 standard compared to reactor-TPOs and soft-TPOs.

Suitable heterophasic propylene copolymers include reactor TPOs and soft TPOs produced with LyondellBasell's Catalloy process technology, which are commercially available under the trade names of Adflex®, Adsyl®, Clyrell®, Hiflex®, Softell®, and Hifax®, such as Hifax® CA 10A, Hifax® CA 12A, and Hifax® CA 60 A, and Hifax CA 212 A. Further suitable heterophasic propylene copolymers are commercially available under the trade name of Borsoft® (from Borealis Polymers), such as Borsoft® SD233 CF.

In case a foamed inorganic material is used, it is generally preferred that the inner surface of the casing, especially the inner surface of the second compartment hosting the foamed material, is operative to form a bond with the foamed inorganic material.

Some polymeric materials are inherently operational to form a bond with mineral binder compositions whereas other materials may require subjecting the surface of the material to one or more pre-treatment steps, either by using a reactive or non-reactive primer or with a flame (“flaming”), oxofluorination, plasma, corona, or similar techniques. Adhesion of the foamed inorganic material to the inner surface of the casing can also be improved by using contact layers, such as those based on adhesive compositions or porous materials, for example, non-woven or woven fabrics.

According to one or more embodiments, the polymeric material of the casing comprises:
A) At least 35 wt.-%, preferably at least 50 wt.-%, more preferably at least 55 wt.-%, even more preferably at least 60 wt.-%, still more preferably at least 65 wt.-%, of the at least one polymer P,
B) 1.5-65 wt.-%, preferably 2.5-50 wt.-%, more preferably 5-45 wt.-%, even more preferably 10-40 wt.-%, still more preferably 15-35 wt.-%, of at least one inorganic filler F, all proportions being based on the total weight of the polymeric material.

According to one or more embodiments, the at least one polymer P comprises at least one ethylene vinyl acetate copolymer P1. Preferably the at least one ethylene vinyl acetate copolymer P1 has a content of a structural unit derived from vinyl acetate of at least 5 wt.-%, more preferably at least 15 wt.-%, even more preferably at least 25 wt.-%, still more preferably at least 35 wt.-%, most preferably at least 45 wt.-%, based on the weight of the copolymer.

According to one or more embodiments, the at least one ethylene vinyl acetate copolymer P1 has a content of a structural unit derived from vinyl acetate of 5-95 wt.-%, preferably 15-90 wt.-%, more preferably 25-90 wt.-%, even more preferably 35-90 wt.-%, still more preferably 45-90 wt.-%, based on the weight of the copolymer.

According to one or more preferred embodiments, the at least one ethylene vinyl acetate copolymer P1 has a content of a structural unit derived from vinyl acetate of 35-95 wt.-%, preferably 45-95 wt.-%, more preferably 55-90 wt.-%, even more preferably 65-90 wt.-%, still more preferably 70-90 wt.-%, based on the weight of the copolymer.

Ethylene vinyl acetate copolymers having the content of a structural unit derived from vinyl acetate in the above cited ranges are especially suitable for use in the polymeric material of the casing since they have been found out to improve the ability of the casing to form a bond with a foamed inorganic material.

According to one or more embodiments, the at least one ethylene vinyl acetate copolymer P1 comprises at least 15 wt.-%, preferably at least 25 wt.-%, more preferably at least 35 wt.-%, still more preferably at least 50 wt.-%, of the total weight of the at least one polymer P.

Suitable compounds for use as the least one inorganic filler F include inert mineral fillers and mineral binders.

The term “inert mineral filler” refers herein to mineral fillers, which, are substantially insoluble in water and unlike mineral binders do not undergo a hydration reaction in the presence of water. Suitable inert mineral fillers include, for example, sand, granite, calcium carbonate, magnesium carbonate, clay, expanded clay, diatomaceous earth, pumice, mica, kaolin, dolomite, xonotlite, perlite, vermiculite, Wollastonite, barite, cristobalite, silica, fumed silica, fused silica, glass beads, hollow glass spheres, ceramic spheres, bauxite, comminuted concrete, and zeolites.

Suitable mineral binders for use as the least one inorganic filler F include hydraulic binders, such as cement and hydraulic lime, calcium sulfate hemihydrate, anhydrite, air-hardening binders, such as non-hydrated lime, and latent hydraulic and/or pozzolanic binder materials.

According to one or more embodiments, the at least one inorganic filer F comprises or is composed of at least one inert mineral filler and/or at least one mineral binder, wherein the at least one inert mineral filler is preferably selected from the group consisting of sand, granite, calcium carbonate, magnesium carbonate, clay, expanded clay, diatomaceous earth, pumice, mica, kaolin, dolomite, xonotlite, perlite, vermiculite, Wollastonite, barite, cristobalite, silica, fumed silica, fused silica, glass beads, hollow glass spheres, ceramic spheres, bauxite, comminuted concrete, and zeolites and wherein the at least one mineral binder is preferably selected from the group consisting of Portland cement, calcium aluminate cement, calcium sulfoaluminate cement, hydraulic lime, calcium sulfate hemihydrate, anhydrite, non-hydrated lime, latent hydraulic binder materials, and pozzolanic binder materials.

The at least one inorganic filler F is preferably present in the thermoplastic material in form of finely divided particles, preferably having a median particle d₅₀ size of not more than 500 μm, more preferably not more than 250 μm, even more preferably not more than 100 μm. The term “particle size” refers to the area-equivalent spherical diameter of a particle.

The term median particle size d₅₀ refers to a particle size below which 50% of all particles by volume are smaller than the d₅₀ value. A particle size distribution can be determined by sieve analysis according to the method as described in ASTM C136/C136M-14 standard (“Standard Test Method for Sieve Analysis of Fine and Coarse Aggregates).

According to one or more embodiments, the at least one inorganic filler F has a median particle d₅₀ size of 0.1-100 μm, preferably 0.1-50 μm, more preferably 0.1-25 μm, even more preferably 0.1-10 μm, still more preferably 0.1-5 μm.

The preferences given above for the at least one mineral binder B, the at least one synthetic organic polymer SP, the at least one surfactant S, the at least one polymer P, and the at least one inorganic filler F apply equally to all other subjects of the present invention unless stated otherwise.

Another subject of the present invention is a method for producing a green wall element (1) of the present invention, the method comprising steps of:
I) Proving a casing (2) having a first and a second compartment (6, 6′) as defined above,
II) Providing a foamed composition,
III) At least partially filing the second compartment (6′) of the casing (2) with the foamed composition, and
IV) Letting the foamed composition to harden.

Preferably, the foamed composition has a density of not more than 500 kg/m3 (g/i), preferably not more than 300 kg/m³ (g/l), more preferably not more than 250 kg/m³ (g/l), even more preferably not more than 200 kg/m³ (g/l), such as 15-250 kg/m³ (g/l), preferably 25-150 kg/m³ (g/l).

Step II) of the method for providing the foamed composition can be conducted before or simultaneously with the step III) of filling the second compartment of the casing with the foamed composition. According to one or more embodiments, step II) is conducted before step III).

According to one or more embodiments, the foamed composition is a foamed synthetic organic composition, preferably selected from the group consisting of polystyrene, polyurethane, polyisocyanurate, and polyolefin foam composition, and expanded rubber composition, more preferably from the group consisting of polystyrene, polyurethane, polyisocyanurate, and polyolefin foam composition.

According to one or more embodiments, the foamed composition is a foamed inorganic composition comprising:
a) At least one mineral binder B,
b) Optionally at least one synthetic organic polymer SP,
c) Optionally at least one surfactant S, and
d) Water.

Preferably, the at least one mineral binder B makes up at least 35 wt.-%, preferably at least 50 wt.-%, more preferably at least 65 wt.-%, even more preferably at least 75 wt.-%, of the total weight of the foamed inorganic composition.

According to one or more embodiments, the weight ratio of the amount of the at least one mineral binder B to the amount of the at least one synthetic polymer SP in the foamed inorganic composition is from 100:0 to 70:30, preferably from 100:0 to 80:20.

According to one or more embodiments, the proportion of the at least one synthetic polymer SP is 1-25 wt.-%, preferably 5-15 wt.-%, more preferably 8-12 wt.-%, with respect to the weight of the at least one mineral binder B in the foamed inorganic composition.

According to one or more embodiments, step II) comprises:
separately providing an aqueous foam and an aqueous slurry comprising the at least one mineral binder B and optionally the at least one synthetic organic polymer SP and
mixing the aqueous foam with the aqueous slurry to obtain the foamed inorganic composition.

The at least one synthetic organic polymer SP, if used, is preferably present in the aqueous slurry as a dispersed polymer.

The aqueous slurry can be obtained by providing the at least one synthetic organic polymer SP in form of an aqueous polymer dispersion and/or in form of a re-dispersible polymer powder and mixing the aqueous polymer dispersion and/or the re-dispersible polymer powder with the at least one mineral binder B, optionally with an additional amount of water, using any conventional mixing technique.

An aqueous polymer dispersion of at least one synthetic organic polymer SP can be prepared, for example, by free-radical polymerization using substance, solution, suspension or emulsion polymerization techniques, which are all known to the person skilled in the art, or by mixing a re-dispersible polymer powder(s) with water. Aqueous polymer dispersions comprising two or more different synthetic organic polymers SP can be easily prepared by using mixtures of commercially available aqueous polymer dispersions and/or re-dispersible polymers.

Suitable aqueous polymer dispersions are commercially available, for example from Synthomer (UK) limited under the trade name of Lipaton®, such as Lipaton® SB 2540, Lipaton® SB 3040, and Lipaton® SB 2740 (styrene butadiene copolymers) and under the trade name of Plextol®, such as Plextol E 303 and Plextol X 4002 (pure acrylics);
from Celanese under the trade name of Mowilith®, such as Mowilith® LDM 7978 (acrylic) and Mowilith® LDM 7651 (styrene acrylic);
from BASF under the trade name of Acronal®, such as Acronal® V 278 (acrylate), Acronal® V 212 (acrylate), Acronal® 81 D (acrylate), Acronal® 4 F(acrylate),
Acronal® DS 5017 (pure acrylate), and Acronal® A 107 (pure acrylate); from Airproducts under the trade name of Airflex®, such as Airflex® EF811 (vinyl acrylic copolymer);
from Arkema under the trade name of Encor®, such as Encor® flex 187 (acrylic), Encor® 123 (styrene acrylic), Encor® flex 192 (styrene acrylic), and Encor® 9176 (styrene acrylic);
from Wacker Chemie under the trade name of Vinnapas®, such as Vinnapas® EAF 60 and Vinnapas® EAF 67 (vinyl acetate/ethylene/acrylate polymer); and from Dow Chemicals under the trade name of Primal®, such as Primal® CA-162 and Primal® CA-172 (acrylic).

It may be preferably to use the at least one synthetic organic polymer SP in form a re-dispersible polymer powder for obtaining the aqueous slurry. Re-dispersible polymer powders are generally produced by spray-drying techniques from aqueous polymer dispersions. Re-dispersible polymer powders may further comprise one or more compounds selected from colloidal stabilizers and antiblocking agents. Examples of re-dispersible polymer powders and methods for producing thereof are disclosed, for example, in patent application US 2005/0014881 A₁.

Suitable re-dispersible polymer powders are commercially available, for example

from Wacker Chemie under the trade name of Vinnapas®, such as Vinnapas® 2000 series, Vinnapas® 3000 series, Vinnapas® 4000 series, Vinnapas® 5000 series, Vinnapas® 7000 series, and Vinnapas® 8000 series; and from Synthomer under the trade name of Axilat®, such as Axilat® HP 8000 series, Axilat® UP series, Axilat® PSB 150 (styrene butadiene copolymer), and Axilat® PAV series (vinyl acetate vinyl versatate copolymer).

The aqueous foam comprises or consists of gaseous bubbles enclosed by liquid walls. The gas of the bubbles can be any type of gas, such as air, nitrogen, carbon dioxide, a noble gas, or mixtures thereof, preferably air.

The aqueous foam is preferably prepared by mechanical foaming of an aqueous mixture in the presence of a gas, particularly air, nitrogen and/or carbon dioxide and/or a noble gas. Mechanical foaming refers to a method in which the gaseous bubbles are introduced into the water of the aqueous foam by mixing the gas with water without performing any gas producing chemical reactions.

According to one or more embodiments, the foaming is conducted in absence of chemically acting pore-forming agents and/or chemically acting foaming agents. In absence of a chemically acting pore-forming agent and/or a chemically acting foaming agent means that a proportion the chemically acting pore-forming agent and/or the chemically acting foaming agent is lower than 0.1 wt.-%, especially lower than 0.01 wt.-%, particularly lower than 0.001 wt.-%, with respect to the weight of the water of the aqueous foam. Most preferably, there is no chemically acting pore-forming agent and/or chemically acting foaming agent present.

According to one or more embodiments, the aqueous foam is obtained by mechanical foaming an aqueous mixture with gas, preferably with air.

Preferably, the aqueous foam comprises the at least one surfactant S, preferably an anionic surfactant and/or a non-ionic surfactant. Surfactants help to stabilize the foam structure of the aqueous foam. Suitable types of surfactants have already been discussed above. It may further be preferred that the at least one surfactant S is provided in the aqueous mixture before foaming.

The at least one surfactant S preferably makes up 0.001-10 wt.-%, more preferably 1-4 wt.-%, even more preferably 2-3 wt.-%, of the total weight of the aqueous foam.

According to one or more embodiments, the aqueous slurry further comprises at least on solid filler SF. Suitable compounds for use as the at least one solid filler SF include inorganic, organic, and synthetic organic materials that do not undergo a hydration reaction in the presence of water and that are substantially insoluble in water. Particularly, the at least one solid filler SF is chemically and/or physically different from the other constituents of the foamed inorganic composition.

Preferably, the at least one solid filler SF has a water-solubility of less than 0.1 g/100 g water, more preferably less than 0.05 g/100 g water, even more preferably less than 0.01 g/100 g water, at a temperature of 20° C. The solubility of a compound in water can be measured as the saturation concentration, where adding more compound does not increase the concentration of the solution, i.e. where the excess amount of the substance begins to precipitate. The measurement for water-solubility of a compound in water can be conducted using the standard “shake flask” method as defined in the OECD test guideline 105 (adopted 27 Jul. 1995).

The particle size of the at least one solid filler SF is not particularly restricted and submicron-sized particles, micrometer-sized particles, millimeter-sized particles up to centimeter-sized particles are all suitable.

Preferably, the at least one solid filler SF has maximum particle size of not more than 20 mm, more preferably not more than 5 mm, even more preferably not more than 2.5 mm, still more preferably not more than 1.5 mm.

According to one or more embodiments, the at least one solid filler SF is selected from the group consisting of sand, limestone, artificial stone, quartz flour, quartz sand, baryte, talc, dolomite, wollastonite, mica, perlite, pumice, vermiculite, norlite, fly ash, micro silica, kaolin, metakaolin, silica fume, fumed silica, granulated blast-furnace slag, foamed blast furnace slag, volcanic slag, expanded clay, expanded shale, expanded slate, foamed glass, pozzolans, diatoms, ceramic particles, ceramic spheres, and porous silica.

Preferably, a proportion of the at least one solid filler SF is 0.001-25 wt.-%, more preferably 0.001-10 wt.-%, still more preferably 0.001-5 wt.-%, with respect to the total weight of the at least one mineral binder B in the aqueous slurry.

According to one or more embodiments, the aqueous slurry further comprises at least one plasticizer PL. Suitable plasticizers are liquid inert organic substances having a low vapor pressure, preferably having a boiling point of above 200° C. measured at a pressure of 1 bar.

According to one or more embodiments, the at least one plasticizer PL is selected from the group consisting of lignosulfonates, gluconates, naphtalenesulfonates, melamine sulfonates, vinyl copolymers, polycarboxylate ethers, adipic and sebacic acid plasticizers, phosphoric acid plasticizers, citric acid plasticizers, fatty acid esters and epoxidised fatty acid esters, benzoates, phthalates, and esters of 1,2-dicarboxy cyclohexane. Polycarboxylate ethers are mentioned as preferred plasticizers. Particularly, the at least one plasticizer PL is chemically different from the at least one synthetic organic polymer SP.

A proportion of the at least one plasticizer PL, especially of the polycarboxylate ether, is preferably 0.001-5 wt.-%, more preferably 0.01-1 wt.-%, with respect to the total weight of the at least one mineral binder B in the aqueous slurry.

Furthermore, other additives may be added to the aqueous foam and/or to the aqueous slurry.

Such additives may be thickening agents, viscosifying agents, accelerators, setting retarders, colored pigments, hollow glass beads, film forming agents, hydrophobic agents or de-polluting agents, for example zeolites or titanium dioxide, latex, organic or mineral fibers, mineral additions or their mixtures. Preferably, the additives do not comprise any defoaming agents.

The term “thickening agent”, is generally to be understood as any compound making it possible to maintain the heterogeneous physical phases in equilibrium or facilitate this equilibrium. Suitable thickening agents are preferably gums, cellulose or its derivatives, for example cellulose ethers or carboxy methyl mellulose, starch or its derivatives, gelatine, agar, carrageenans and/or bentonite clays.

Accelerators for hydraulic binders are well known, and any solidification and hardening accelerators may be used in the present invention. For example, the accelerator may be selected from aluminum hydroxide, aluminum sulphate, carboxylic acids, metal oxides, metal hydroxides, inorganic acids, alkali hydroxide, alkali metal silicates nitrates, and/or nitrites. Particularly advantageous accelerators include aluminum-containing accelerators, such as aluminum sulphate.

Preferably, the accelerator, especially an aluminum compound, may be used in an amount of 0.15-5 wt.-%, preferably 0.25-3 wt.-%, especially 0.5-2.5 wt.-%, with respect to the total weight of the at least one mineral binder B in the aqueous slurry.

The aqueous foam and the aqueous slurry of the mineral binder B are preferably mixed with each other under overpressure conditions. Preferably, at an overpressure of 1-15 bar, especially 2-5 bar, with respect to the environmental air pressure. This allows for easily adjusting the density of the foamed mineral binder composition in wide ranges.

Most preferably, the mixing is conducted using a static mixer, whereby, preferably, the aqueous foam and the aqueous slurry of the mineral binder B are driven by pressurized air through the static mixer. Preferably, the pressurized air has a pressure of 1-15 bar, especially 6-10 bar, above the environmental air pressure. Thereby, a stable foamed mineral binder composition is obtainable in a reliable manner. The aqueous foam may be mixed with the slurry either batch-wise or continuously.

The weight ratio of water to the at least one mineral binder B in the aqueous slurry is preferably 0.2-0.7, more preferably 0.25-0.5, even more preferably 0.3-0.4.

Another subject of the present invention is a green wall comprising a substrate (8) and one or more modular green wall elements (1) according to the present invention attached to a surface of the substrate.

Each green wall element is preferably attached to the surface of the substrate via an outer surface of its rear wall (3′).

According to one or more embodiments, adjacent green wall elements are attached to each other via outer surfaces of their opposing longitudinal side walls (4, 4′).

The substrate (8) is preferably a building element, particularly a wall or façade of a building.

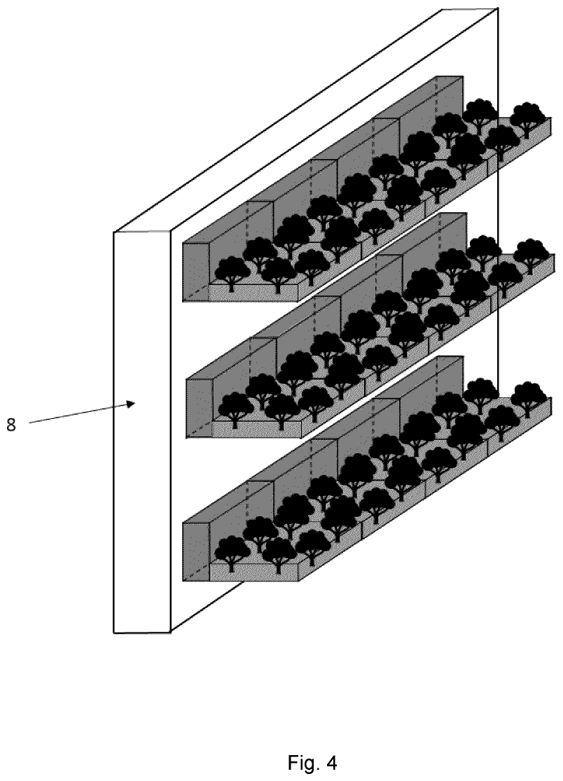

The green wall elements can be arranged on the surface of the substrate (8) in any arbitrary pattern, for example such that the elements line up in rows, as shown in FIG. 4, or such that they are offset between rows.

Still another subject of the present invention is a method for providing a green wall, the method comprising steps of:
I. Providing one or more modular green wall elements according to the present invention,
II. Attaching the element(s) to a surface of a substrate (8) such that each element (1) is directly or indirectly connected to the surface of the substrate via an outer surface of the rear wall (3′), and
III. Optionally attaching adjacent elements to each other via outer surfaces of the opposing longitudinal side walls (4, 4′).

The substrate (8) is preferably a building element, particularly a wall or façade of a building.

The green wall elements can be attached to the surface of the substrate and/or to each other using any conventional means, such as by using mechanical fastening or adhesive or thermal bonding means Suitable mechanical fastening means for attaching the green wall elements to the surface of the substrate and/or to each other include metal bars, screws, nails, clevis bolts, wire mesh elements, and fastening brackets.

Suitable adhesives for attaching the green wall elements to the surface of the substrate and/or to each other include, for example, one-component and multiple-component reactive and non-reactive polyurethane, acrylic, and epoxide adhesives. Suitable adhesives include pressure sensitive adhesives, contact adhesives, and structural adhesives.

The term “thermal bonding means” is refers to a process, where thermal energy is applied to at least partially melt the composition of at least one of the substrates followed by contacting the opposing surfaces of the substrates with each other, preferably under the influence of pressure, and cooling the substrates, which results in formation of a bond between the layers without use of an adhesive.

According to one or more embodiments, at least 50%, preferably at least 75%, more preferably at least 85%, of an outer surface of the rear wall (3′) of each element is directly or indirectly connected to the surface of the substrate (8). It may also be preferred that the rear wall (3′) of each element is directly or indirectly connected over its substantially entire outer surface to the surface of the substrate (8). The expression “substantially entire surface” is understood to mean at least 95%, preferably at least 97.5%, more preferably at least 99%, of the respective surface.

1. A modular green wall element comprising a casing having a first and a second compartment, wherein the first compartment is arranged to host a growing material for plants and wherein the second compartment is at least partially filled with a foamed material.

2. The element according to claim 1, wherein the foamed material has a density of not more than 500 kg/m³ (g/l).

3. The element according to claim 1, wherein the foamed material is a foamed synthetic organic or inorganic material.

4. The element according to claim 1, wherein the foamed material is a foamed inorganic material comprising:
a) at least one mineral binder B and
b) optionally at least one synthetic organic polymer SP.

5. The element according to claim 4, wherein the at least one mineral binder B comprises at least 35 wt.-%, of the total weight of the foamed inorganic material.

6. The element according to claim 4, wherein the at least one mineral binder B is selected from the group consisting of Portland cement, calcium aluminate cement, calcium sulfoaluminate cement, latent hydraulic binder materials, pozzolanic binder materials, calcium sulfate, and hydrated lime.

7. The element according to claim 4, wherein the weight ratio of the amount of the at least one mineral binder B to the amount of the at least one synthetic polymer SP in the foamed inorganic material is from 100:0 to 70:30.

8. The element according to claim 1, wherein the casing has:
front and rear walls connected by two longitudinal side walls,
an intermediate wall dividing the inner space formed between the front, rear, and longitudinal side walls into the first and second compartments, and
a bottom wall.

9. The element according to claim 8, wherein the intermediate wall extends transversely to the direction of the longitudinal side walls.

10. The element according to claim 8, wherein the depth of the second compartment measured in direction of the longitudinal side walls is at least 10% smaller than the depth of the first compartment measured in direction of the longitudinal side walls.

11. The element according to claim 1, wherein the element is arranged to be attached to a surface of a substrate via an outer surface of the rear wall facing away from the intermediate wall.

12. The element according to claim 1, wherein the casing is composed of a polymeric material.

13. A method for producing a modular green wall element according to claim 1 comprising steps of:
I) providing a casing having a first and a second compartment,
II) providing a foamed composition,
III) at least partially filing the second compartment with the foamed composition, and
IV) letting the foamed composition to harden.

14. The method according to claim 13, wherein the foamed composition has a density of not more than 500 kg/m³ (g/l).

15. The method according to claim 13, wherein the foamed composition is a foamed inorganic composition comprising:
a) At least one mineral binder B,
b) Optionally at least one synthetic organic polymer SP,
c) Optionally at least one surfactant S, and
d) Water.

16. The method according to claim 15, wherein the at least one mineral binder B comprises at least 35 wt.-%, of the total weight of the foamed inorganic composition.

17. The method according to claim 15, wherein step II) comprises:
separately providing an aqueous foam and an aqueous slurry comprising the at least one mineral binder B and optionally the at least one synthetic organic polymer SP and
mixing the aqueous foam with the aqueous slurry to obtain the foamed inorganic composition.

18. A method for providing a green wall comprising steps of:
I. providing one or more modular green wall elements (1) according to claim 1,
II. attaching the element(s) to a surface of a substrate such that each element is directly or indirectly connected to the surface of the substrate via an outer surface of the rear wall, and
III. optionally attaching adjacent elements to each other via outer surfaces of the opposing longitudinal side walls.

19. The method according to claim 18, wherein the substrate is a building element.
